(19) United States
(12) Patent Application Publication
(10) Pub. No.: US 2012/0060757 A1
(43) Pub. Date: Mar. 15, 2012

(54) UV CURING APPARATUS UTILIZING A COLD CATHODE FLORESCENT LAMP

(76) Inventors: Yu Jen Li, Taipei Hsieng (TW); Kuo Chang Cheng, Taipei Hsieng (TW)

(21) Appl. No.: 12/882,201

(22) Filed: Sep. 15, 2010

(51) Int. Cl. B05C 9/12

(52) U.S. Cl. 118/620

(57) ABSTRACT

The present invention is related to an UV curing apparatus, and more particularly, to an UV CCFL curing apparatus utilizing UV CCFL as light source. In order to provide an curing apparatus capable of generating UV light of high intensity and uniform lighting with great electrical safety and reliability, the UV CCFL curing apparatus of the present invention comprises a detachable UV CCFL light source that is designed and built to operate at high voltage, in a range greater than or equal to one thousand volts, with dielectric plugs and installation guides, and it may preferably include a light-transmissive protective cover to further protect users from direct contact with the UV CCFL light source during the curing operation in the curing chamber of the apparatus and to offer as a further protection to the fragileness of the UV CCFL thin glass tubes, which may too further filter certain wavelength of the UV light, such UVC. The UV CCFL curing apparatus of the present invention is preferably provided for curing UV hardening gel applied onto the nails of multiple fingers or toes all at once. Furthermore, the outer casing of the apparatus is detachably attached to the inner casing to allow a greater user interaction for decorative and entertainment purposes in addition to its protection to the apparatus as a whole.

### FIELD OF THE INVENTION

The present invention relates to an ultraviolet (UV) curing apparatus, and more particularly, to an UV curing apparatus utilizing an UV cold cathode florescent lamp (CCFL) as a light source for solidifying an acrylic gel applied onto the nails of human fingers and toes in multiple at once and as well as those of animal pets.

### BACKGROUND OF THE INVENTION

Energy efficient lights such as cold cathode florescent lamps (CCFLs) of a relatively compact size and having the capability to generate an uniform lighting in multiple directions and angles have been widely adapted in various applications including, for example, backlights of liquid crystal displays (LCDs), general and office lightings. While sharing the merits of traditional compact florescent lamps (CFLs) in producing efficient lighting with great illumination angles and brightness, current CCFLs at the present market contain much less mercury than current CFLs in general in producing efficient lights. In addition to the fact that current CCFLs are greener and more energy efficient than traditional incandescent lamps and CFLs, CCFLs also exhibit the merits of uniform lighting having a great illumination angle of approximately 360 degree comparing to a narrower angle of 120 produced by current light emitting diode (LED) in the market.

In view of the merits of longer lifetime, greater illumination angles and more energy efficient and environmental friendly of the CCFLs in comparison to incandescent bulbs and CFLs, they have also been adopted to produce UV rays. Despite the fact that UV rays can be harmful to the health of human in general since UV is more energetic than visible light and is therefore more dangerous, UV has its unique application in the industry. Certain industrial applications utilize UV rays for curing a specific liquid and such usage of UV has shown merits in printing techniques and creating of protective layers on industrial products. Conventional UV lamps mostly adopts and refers to incandescent lamps that are generally of a shorter lifetime and consumes much greater energy in producing lights than CCFLs. As UV lights are used to curing an acrylic liquid or gel in cosmetic applications to facilitate the creation of nail arts and nail protections, it is advantageous in utilizing CCFLs.

Known UV devices for curing a specific UV hardening gel generally utilize traditional incandescent UV lamps and bulbs. U.S. Pat. No. 4,731,541 “Ultraviolet Light for use in Setting Gels for Artificial Fingernails” to Shoemaker discloses a UV device using traditional incandescent UV lamps for creating a protective layer on human hand nails by exposing the UV hardening gel coated on the nails under the lamp while allowing human hands to rest within the housing. U.S. Pat. No. 5,130,551 “Nail Drying Apparatus” to Nafzigar et al. adopts similar concepts of UV hardening gel and traditional UV lamps but with an improved design capable of receiving both the human hand and toe nails. U.S. Pat. No. 6,518,583 “Optical Exposure in particular a Table Lamp for Hardening Light-Hardening Gel in the courses of Fingernail Treatment” to Henning discloses a UV device for human hands that also utilizes traditional UV lamps but by using more UV incandescent bulbs, the UV lighting area is therefore increased to cover multiple fingernails at once. U.S. Pat. No. 6,762,425 “Portable Device for Curing Gel Nail Preparations” to Strait discloses a UV device for curing gel applied to the nails of both human hands and feet and as the UV compartment and lamps are designed specifically to treat both hands and feet received therein, Strait is able to harden the UV hardening gel applied to not just the nails of fingers but also toes at once.

There are at least two major concerns to the use of such UV devices utilizing traditional incandescent UV lamps with human hands or feet. One is the hazard of having human skin exposed to UV rays under these traditional incandescent UV lamps or bulbs may lead to undesirable skin cancer in a long run as these traditional incandescent UV lamps typically emit three types of UV light in reference to skin protection and these are UVA, UVB, and UVC. Among the three rays, UVC is the most damaging and is the most energetic of the three types. Another major drawback deals with the relatively short lifetime of traditional incandescent lamps requiring frequent maintenance. Typical incandescent UV lamp has a lifetime of 3,000 hrs (or approximately 4 months) and upon which replacements must be performed, which may not be optimal if fixtures or machinery adopting such UV lamps include delicate components and/or electrical plugs and circuitry.

A recent development of UV curing apparatus has been incorporating UV LEDs such that longer life of the light source may be achieved with minimum replacements and energy consumed may be reduced. However, the relatively small illumination angle of LEDs and the cooling required for LEDs to ensure proper lighting and functioning have posed challenges to the design of lighting devices and fixtures. CCFL UV lamps, on the other hand, having a much greater illumination angle and requiring no extra cooling mechanism is one possible solution developed. However, current glass shells and tubes of CCFL lamps in general are much thinner and smaller than conventional lamps and tubes, making CCFL lamps including CCFL UV lamps fragile; safety of the lamps must be taken into consideration in addition to the design of illumination angles, proper UV wavelength and plugs and circuitry.

In view of the foregoing, it is desirable to provide a UV curing device capable of overcoming the drawbacks of the known arts including the ones of traditional incandescent UV lamps and the ones of UV LEDs recited above while producing a safe, reliable, efficient and green light to human as well as the environment. Furthermore, it is also desirable to provide an UV curing device to facilitate the creation of nail arts and nail protections and in particular, an UV curing device capable of curing the nails of multiple fingers or toes all at once safely and effectively with high reliability.

### SUMMARY OF THE INVENTION

In order to overcome the shortcomings described above, one aspect of the present invention is to provide an UV curing apparatus utilizing an UV CCFL light source capable of curing an UV hardening gel such as an acrylic gel by solidifying the gel from liquid to solid state safely and uniformly with an UV wavelength ranging from 350 nm to 450 nm. It is also preferable that the UV CCFL light source is configured and arranged into certain forms and orientations in order to achieve an optimal light intensity within a certain space or area.

Another aspect of the present invention is to provide an UV curing apparatus utilizing at least one UV CCFL with an improved mechanical housing capable of effectively reflecting UV rays emitted from said at least one UV CCFL to produce an uniform illumination within an illumination or curing chamber of the housing. It is also preferable that the mechanical housing further includes a detachable reflective base such that an illumination angle substantially equivalent to 360 degrees may be achieved within said curing chamber depending upon the desired curing effect of the device user.

Still another aspect of the present invention is to provide an UV curing apparatus utilizing at least one UV CCFL with an improved mechanical housing comprising a protective means protecting said at least one UV CCFL from external forces resulting in damages and/or shattering of glass shells. It is also preferable that the protecting means of the mechanical housing too serves as a safety measure in preventing direct contacts of the device user with the UV CCFL during curing operation.

Still another aspect of the present invention is to provide an UV curing apparatus utilizing a replaceable UV CCFL light source that may be detached from the device and its circuitry with ease and of high safety. Despite the thin glass shells and fragile nature of the CCLF light tubes, it is preferable that the UV CCFL of the apparatus may be replaced with ease as dielectric plugs may configured to be of a safe distance apart from each other since UV CCFL are to be energized by a high voltage. The facilitate the replacement of lamps, the electric plugs may too serve as mechanical guides to the securement of the lamps onto the apparatus.

In one embodiment of the present invention, the UV CCFL curing apparatus comprises a light reflective inner casing having a light reflective inner wall enclosing an inner chamber and an outer wall, an detachable outer casing, a replaceable UV CCFL light source retained within said inner chamber and between the inner wall of inner casing and a light-transmissive protective cover via electric plugs thereon and a power supply capable of supplying an electricity of a high voltage electrically connected to the UV CCFL light source via the electric plugs thereof of the UV CCFL light source. During operation, as the electricity of a high voltage, preferably of a magnitude substantially greater than 1,000 volts, is supplied to the UV CCFL light source via the power supply, the UV CCFL light source may then emit an UV light of a range 350 nm to 410 nm capable of curing an UV gel by solidification of the gel via phase change property of such gel as it is being applied onto the nails of an user and exposed under the UV light within the curing apparatus of the present invention.

As the UV CCFL light source of the present invention comprising at least one UV CCFL may require high voltage operation, safety and reliability are significant factors to be considered to the mechanical and electrical designs and structures of the UV curing apparatus of the present invention in addition to providing an uniform UV lighting within the curing chamber of the apparatus. For an optimal safety, in one embodiment, the input electrodes of the electric plugs integrated on the UV CCFL may be spaced apart from each other and may be further comprise dielectric plug cloth. In another embodiment, the UV curing apparatus may further comprise a light-transmissive means or cover positioned to separate the UV CCFL light source from the inner chamber of the inner casing such that an user may be further protected from direct contact with the UV CCFL light source and free from the danger of touching the heated UV CCFL lamp shells and the possible breaking of the thin shells of the UV CCFL. The light-transmissive means may too serve as an extra protection preventing direct contact of the user with the abovementioned electric plugs of the UV CCFL light source operating at high voltage.

In another embodiment, said light-transmissive means or cover of the UV curing apparatus of the present invention may be selected to be of a material or coating capable of providing additional filtering of UV light rays emitted from the UV CCFL light source to serve as an extra preservation of the safe use of UVA and UVB rays, UVA in particular, on human fingers and toes.

In order to provide an uniform lighting in addition to the safety precautions considered above, in one embodiment, the UV CCFL light source may further comprise at least one UV CCFL configured into a certain shape such that the amount of light under a given illumination area may be optimized to a greater light intensity than a lamp tube. In one embodiment, the UV CCFL of the UV CCFL light source may be configured into a spiral shape of a diameter separating two ends of the above-mentioned electric plugs integrated thereon. The UV CCFL of the UV CCFL light source may further comprises light-emitting phosphor capable of emitting light of a short wavelength between 350 nm and 410 nm upon receiving an input light energy transmitted from a mercury vapor contained therein and energized by the high voltage of the electricity, in a magnitude greater than or equal to 1,000 volts, supplied from the power supply.

To facilitate the replacement of the UV CCFL light source of the UV curing apparatus of the present invention, the electric plugs may be further designed to include features assisting user in handling and installing UV CCFL that may be of thin shell and fragile in nature. In one embodiment, the electric plugs integrated on two ends of the UV CCFL of the UV CCFL light source may further comprise guiding spikes extending to the outer wall of the inner casing and electrically connected to the power supply.

To enhance an uniform lighting with increased illumination angles, in one embodiment of the UV curing apparatus of the present invention, a light reflected base plate may be further provided to enhance the curing within the curing chamber of the apparatus. The light reflective base plate may be detachably attached to the inner casing such that UV rays emitted from said UV CCFL light source are reflected by the base plate toward the enclosed inner chamber of the inner casing such that desired illumination with greater angles may be achieved.

In another embodiment of the present invention, an UV CCFL curing apparatus of the present invention comprises a light reflective inner casing having a light reflective inner wall enclosing an inner chamber and an outer wall, a detachable outer casing, a replaceable UV CCFL light source having at least one UV CCFL configured into a spring column with electric plugs disposed on two separated ends of said spring column and integrated thereon, a detachable light-transmissive protective cover retaining the UV CCFL light source thereon and within the inner or curing chamber and a power supply electrically connected to the UV CCFL light source via said electric plugs thereof to supply an electricity of a high voltage to the light source such that an UV gel applied onto a user's nail(s) maybe cured or hardened as it is exposed under the UV light emitted by the UV CCFL light source of the apparatus within said curing chamber.

In another embodiment of the present invention, to enhance the uniform lighting and intensity of the light in the curing chamber of the apparatus, a plurality of UV CCFLs of the UV CCFL light source in the shape of the abovementioned spring column may be disposed in different portions of the inner casing within the curing chamber thereof such that the light intensity under a given illumination area may be optimized and desired illumination angle may be obtained. In one embodiment, the two ends of each of the UV CCFL of the UV CCFL light source in said spring column shape may too be integrated with electric plugs spaced apart from each other in transmitting electricity at high voltage as the UV CCFLs disposed on different portions of the curing chamber to emit light at a short wavelength between 350 nm and 410 nm.

The foregoing summary recites preferred embodiments of the present invention and is for illustrative purposes. Embodiments of the present invention may be implemented in various different ways and shall too be considered as part of the present invention within its scope. Details of the exemplary embodiments of the present invention will be further described in the following.

### BRIEF DESCRIPTION OF THE DRAWINGS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

FIG. 1 is a front perspective view of an UV CCFL curing apparatus according to one embodiment of the present invention;

FIG. 2 is an exploded view of the UV CCFL curing apparatus of the present invention in FIG. 1;

FIG. 3 is a front perspective view of the UV CCFL of the UV CCFL light source according to one embodiment of the present invention;

FIG. 4 shows an enlarged view illustrating the separation of the detachable light-transmissive protective cover from the UV CCFL retained on the inner casing of the apparatus according to one embodiment of the present invention;

FIG. 5 shows a front exploded view of an UV CCFL curing apparatus according to another embodiment of the present invention.

### DESCRIPTION OF EMBODIMENTS OF THE INVENTION

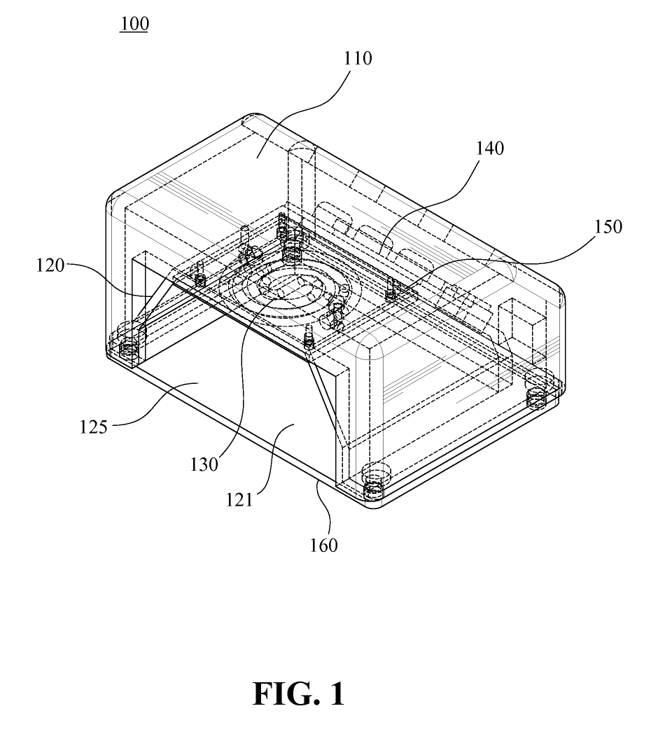

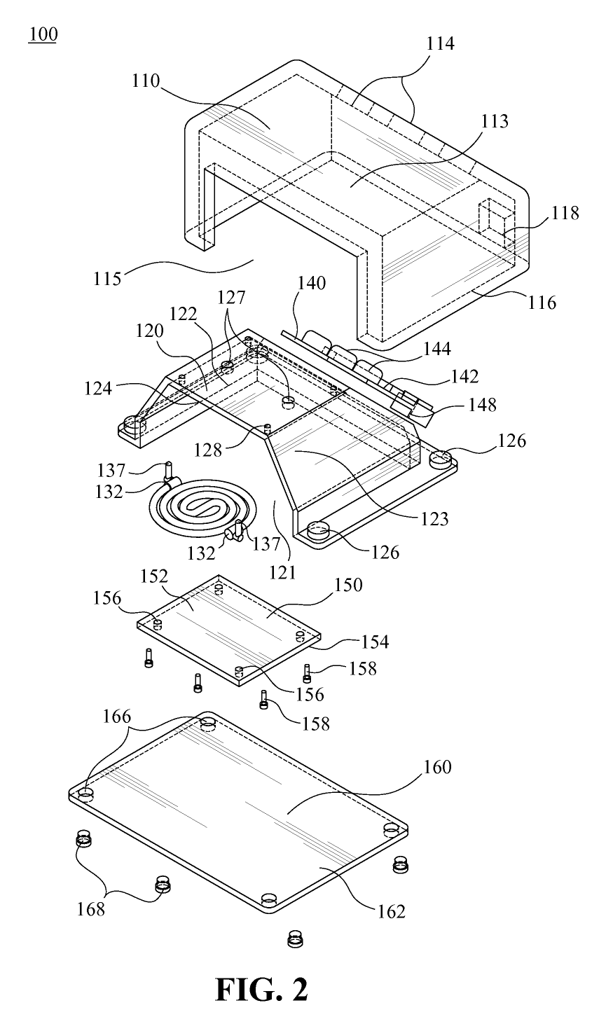

FIGS. 1 and 2 show an exemplary embodiment of an UV CCFL curing apparatus 100 of the present invention, the UV CCFL curing apparatus 100 utilizes an UV CCFL light source to provide UV light of desired wavelength(s) to objects applied with an UV hardening gel, in particular, gel applied to the nails of multiple fingers or toes placed or received within the apparatus such that it may transform a liquid-phase gel to a solid-phase layer. In one embodiment of the present invention as shown in the figures, the UV CCFL curing apparatus 100 comprises an outer casing 110, a light reflective inner casing 120 having a light reflective inner wall 124 enclosing an inner chamber 125 and an outer wall 122; wherein the inner or curing chamber 125 includes a front opening 121 facing toward a front side of the apparatus 100 and an UV CCFL light source 130 detachably attached to the inner casing 120 to provide UV light toward the inner chamber 125 of the inner casing 120. The UV CCFL light source 130 may preferably be protected by an addition of a light-transmissive protective cover or means 150 positioned beneath the UV CCFL light source 130 such that the UV CCFL light source 130 may be sandwiched between the inner casing 120 and the protective cover 150, preventing hazards including user's direct contact with the UV CCFL light source 130 during curing operation in the curing chamber 125 and possible breakage of the glass shell of the UV CCFL light source. The protective cover 150 may too serve as a supporting substrate for the UV CCFL light source 130 detachably attached to the inner casing 120. In addition, while the detachable outer casing 110 may also serve as a protective means of the UV CCFL curing apparatus 100 as a whole, it may too offer greater user interactions for entertainment purposes by incorporating certain outer appearance depending on user's selection and desire.

As shown in FIG. 2, according to one embodiment of the present invention, the UV CCFL curing apparatus 100 comprises a light reflective inner casing 120 having a light reflective inner wall 124 enclosing an inner chamber 121. The outer wall 122 of the light reflective inner casing 120 may be configured such that it may be fitted to an outer casing 110 and onto which the outer casing 110 may be detachably attached to by means of for example, magnets, fixations including screws and bolts or press fits. Said inner chamber 121 also includes a front opening 125 facing toward a front side of the apparatus 100. It can be understood that in another embodiment, the front opening 125 may too be configured to include a plurality of openings for receiving user fingers and toes therein. As shown in the figure, in one embodiment, the inner wall 124 of the inner casing 120 comprises a plurality of planes 123 angled from one another, preferably at an angle between 90 degree and 175 degree to facilitate the reflection of UV light within the inner chamber 121 enclosed by said planes 123 of the inner casing 120. In still another embodiment, said plurality of planes 123 angled from one another of the inner casing 120 may include a horizontal top plane that may too be substantially flat to facilitate the installation of a UV CCFL light source detachably attached thereon. Details of the UV CCFL light source are provided in the later content.

The outer casing 110 may be provided as both a protection means to the UV CCFL curing apparatus 100 of the present invention as well as an interactive means accepting configurations of different outer appearances based on user's preference and selection from a customized set of outer casing 110. In other words, the outer wall 113 of the outer casing 110 may be of a certain desired appearance and the front side thereof may too include at least one opening to receive user's fingers or toes. Apertures 114 and 118 may be further provided for functional buttons and electrical plugs. As mentioned previously, the outer casing 110 may be detachably attached to the outer wall 122 of the inner casing 120 and in one embodiment, said detachable attachment may be provided at the bottom 116 of the outer casing 110 by means of for example magnets, fixations including screws and bolts as well as sliding/mating slots or press fits.

The UV CCFL curing apparatus 100 of the present invention utilizes an UV CCFL light source 130 that may be configured to be fitted onto the inner casing 120 of the apparatus 100 and to be detachably attached thereon to facilitate the maintenance and replacement of the light source 130. In one embodiment of the present invention, the UV CCFL light source 130 comprises at least one UV CCFL detachably retained on the light reflective inner wall 124 of inner casing 120 via electric plugs 132 integrated or provided on two electrode ends of the UV CCFL light source 130. During curing operation, the UV CCFL light source 130 is capable of curing an UV hardening gel such as acrylic gel and upon receiving the UV light, the UV hardening gel may transform from a liquid-like state to a solid state. According to the design and dimensional specification and requirement of the UV curing apparatus 100 of the present invention, the at least one UV CCFL of the UV CCFL light source 130 may be customized to provide an uniform lighting with a desired light intensity under a given illumination area as explained in the subsequent content.

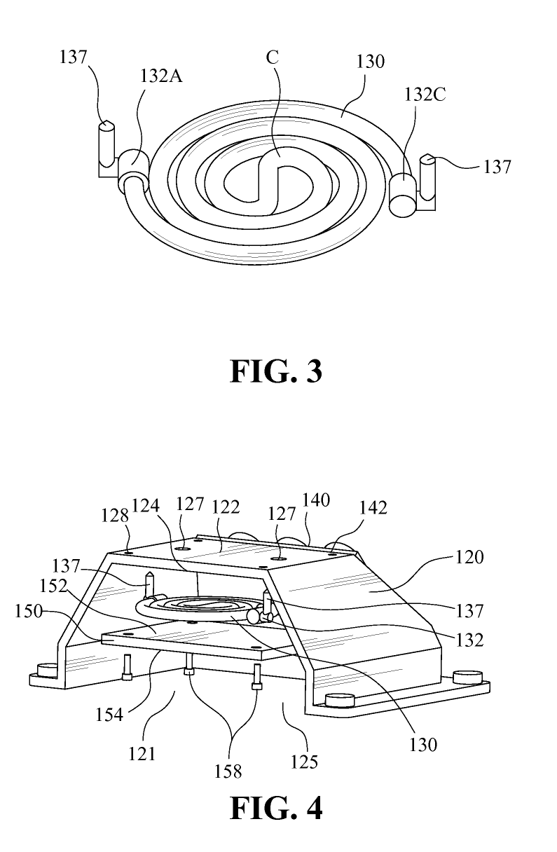

Referring to FIG. 3, FIG. 3 shows an embodiment of an UV CCFL of the UV CCFL light source 130 of the present invention. To be installed onto and received in the curing chamber 121 of the apparatus 100, in one embodiment, the UV CCFL light source 130 may be customized into a spiral shape as shown in the figure. The spiral shape of the UV CCFL light source may be of a diameter D with respect to the center C thereof; and wherein the diameter D is preferably to be less than the width of the apparatus 100 or more particularly, less than the width of the inner casing 120 of the apparatus 100. One advantage of configuring said UV CCFL light source 130 into a spiral shape as shown in the figure is the increase of the illumination intensity for a given illumination area exposed to said light source. In one embodiment, the UV CCFL of the UV CCFL light source 130 further comprises light-emitting phosphor capable of emitting light of a short wavelength between 350 nm and 410 nm upon receiving an input light energy transmitted from a mercury vapor contained therein and energized by the high voltage of the electricity supplied from the power supply 140 connected to an external source (not shown). Given the fact that a single UV CCFL of the UV CCFL light source 130 is generally formed from a strip of CCFL tube having a thin glass shell of a relative small tubular cross-section, the spiral shape of the UV CCFL may be advantageously curved to provide higher intensity and to prevent sudden and sharp curvature or turns where inconsistent light distribution may occur during operation. In other words, the inventor understands that as an incoherent distribution of light emitting UV phosphor within the UV CCFL light tube may occur at sharp curvatures of the light tube, such as curvatures near or over 180 degree, which may then result in inconsistent light distribution especially at these sharp curved regions of the light tube, said spiral shape of the UV CCFL light tube of the UV CCFL light source 130 is preferably provided to achieve the desired uniform lighting and illumination intensity.

In one embodiment of the present invention, an UV CCFL of the UV CCFL light source 130 further comprises electric plugs 132A and 132C integrated thereon and may be arranged on two ends thereof separated by a width or diameter D of the UV CCFL with respect to the center C thereof; and wherein said two ends may be electrodes of the UV CCFL. As UV CCFL requires a high voltage startup during its operation, said two electrodes may be operated generally at voltage greater than or equal to one thousand volts. Since inventor understands such high voltage operation requirement of UV CCFL, or CCFL in general, the width and diameter D of the UV CCFL light source 130 is designed and selected to prevent any electricity leakage or voltage jump at said electrodes; in one preferred embodiment, the diameter D may be greater than or equal to 30 mm and in another embodiment, it is preferably to be approximately 60 mm; such that the electricity of said high voltage supplied from the power supply 140 from an external source (not shown), such as a AC source, is transmitted to said two ends or electrodes of the UV CCFL 130 spaced apart from each other. Furthermore, in one embodiment, the electric plugs 132, or 132A and 132C, provided or integrated on the electrodes of the UV CCFL light source 130 are preferably to be made of a dielectric material selected from any one of the materials of: silicon, plastic or ceramics. In still another embodiment of the present invention, said electric plugs 132, 132A and 132C, integrated on an UV CCFL of the UV CCFL light source 130 may further comprise conductive guiding spikes 137. The conductive guiding spikes 137 may serve as a both guiding means as well as a connection means electrically connected to the power supply 140 via connection cables (not shown). As conductive guiding spikes 137 extending to the outer wall 122 of the inner casing 120, they assist the retaining of the UV CCFL light source 130 on said inner casing 120 within the inner chamber 121 while providing electrical connection to the power supply 140 and the external power source (not shown). In addition, the conductive guiding spikes 137 may not only prevent user's direct contact with the electrodes of the UV CCFL light source 130 operating at high voltage but also facilitate the installation of the UV CCFL light source 130 onto the apparatus 100 during its maintenance and light source replacement.

FIG. 4 illustrates an exemplary attachment of the UV CCFL light source 130 and a light-transmissive protective means 150 onto the inner casing 120 of the UV CCFL curing apparatus 100 according to one embodiment of the present invention. As shown in the figure, in one embodiment, the UV CCFL light source 130 may be detachably retained on a horizontal top plane 123 of the inner wall 124 of the inner casing 120. The light-transmissive protective means 150 comprises a first side 152 and a second side 154 opposite to the first side 152 and is configured to detachably secured to the inner casing 120 and to receive the UV CCFL light source 130 between said first side 152 thereof and the inner wall 124 of the inner casing 120. In one embodiment, the light-transmissive protective means or cover 150 has the first side 152 facing toward the UV CCFL light source 130 and the second side 154 facing toward the inner chamber 121 of the inner casing 120 and may too be detachably attached to the inner casing 120 by any one of the following fixation means including screws, bolts and magnets.

The light-transmissive means or cover 150 may allow and/or filter UV light emitted by the UV CCFL light source 130 in the curing chamber 121 and at the same time, it may prevent user's direct contact with the UV CCFL light source 130 during the curing operation of the apparatus 100 as a safety measure considering the heated light tube and the high voltage electrodes of the UV CCFL light source 130 during operation as well as the fragileness of the thin glass tubes of the UV CCFL light source 130. In one embodiment as shown in FIG. 4, the light-transmissive protective means may be detachably secured to the inner casing 120 at a distance away from the inner wall 124 of the inner casing 120 such that the at least one UV CCFL of the UV CCFL light source 130 may be received between the first side 152 of the protective means 150 and the inner wall 124 of the inner casing 120 and preferably via the apertures 127 provided to receive the abovementioned conductive spikes 137 of the light source 130. The light-transmissive protective cover 150 may too be secured onto the inner casing 120 by means of fixation 158; and in one embodiment as shown in the figure, it may be secured onto the inner casing 120 via screws, bolts, magnets or inserts 158 via through-holes 156 onto the corresponding sockets 128 formed on the inner casing 120. Furthermore, in an exemplary embodiment of the present invention, the light-transmissive protective means 150 may be a cover made of any one of the following materials including: PMMA, PC, silicon, quartz.

Referring to FIG. 2 again, according to one embodiment of the present invention, the UV CCFL curing apparatus 100 further comprises a light reflective base plate 160 detachably attached to the inner casing 120 such that UV rays emitted from said UV CCFL light source 130 may b reflected by the base plate 160 toward the enclosed inner chamber 121 of the inner casing 120. The light reflective base plate 160 may be provided to enhance the reflection of the UV light within the curing chamber 121 during the operation of the apparatus 100 upon the desire of the user; therefore, it is preferable that the upper surface 162 may be coated or provided with a layer of UV reflective material such as zinc or other metal or metal alloys. In still another embodiment, the light reflective base plate 160 may be detachably attached to the inner casing 120 by any one of the following fixation means 166 including screws, bolts and magnets such as via the through-holes 168 formed thereon.

As the power control unit or power supply 140 of the present invention may be connected to an external source (not show) and may be capable of supplying an electricity of a high voltage, in one embodiment, the power supply 140 comprises an external adaptor (not shown), a power plug 148 and a substrate or PCB 142 attached to the inner casing 120, preferably on the outer wall 122 of the inner casing 120, and electrically connected to the UV CCFL light source 130 via said electric plugs 132 thereof. As mentioned previously, the high voltage supplied by the power supply 140 and from the external power source via the power adapter to the at least one UV CCFL of the UV CCFL light source 130 is substantially greater than one thousand volts. Furthermore, to facilitate user's interaction and control of the apparatus 100, the power supply 140 further comprises at least one button 144 electrically connected to the substrate 142 and extending to an external of the outer casing 110. In an exemplary embodiment, the power supply 140 may be connected to an external AC power source (not shown) and upon receiving an electricity, said power adaptor, preferably built external to the apparatus 100, may elevate the input voltage form the power source to the required one thousand volt, which may be further transformed from AC to DC by an addition of an inverter also built either external or internal to the apparatus 100 of the present invention prior to the input of such electricity to said power supply 140 thereof and subsequently to the UV CCFL light source 130.

During an exemplary operation of the UV CCFL curing apparatus 100 of the present invention, an user may first input the desired curing time via the abovementioned buttons 144 electrically connected to the power supply 140. Once the curing time is set, the UV CCFL light source 130 shines UV light of a wavelength preferably in the range between 350 nm and 410 nm in the curing chamber 121 of the inner casing 120 of the apparatus 100. During the curing operation, user's fingers or toes may be applied with an UV hardening gel and upon exposure to the UV light in the curing chamber 121 of the apparatus, the UV hardening gel may be transformed from a liquid-state to a solid state after a prescribed period of time depending upon the wattage of the UV CCFL light source 130 used and the type of the UV hardening gel used. Examples of UV hardening gel, such as an acrylic type gel, including urethane-methacrylate and epoxy-methacrylate from manufacturers such as Keystone®, BIO®, CNC®, COSMEX™. The introduction of an UV LED kit that may include the UV CCFL curing apparatus of the present invention together with any UV hardening gel shall too be considered to be within the scope of the present invention.

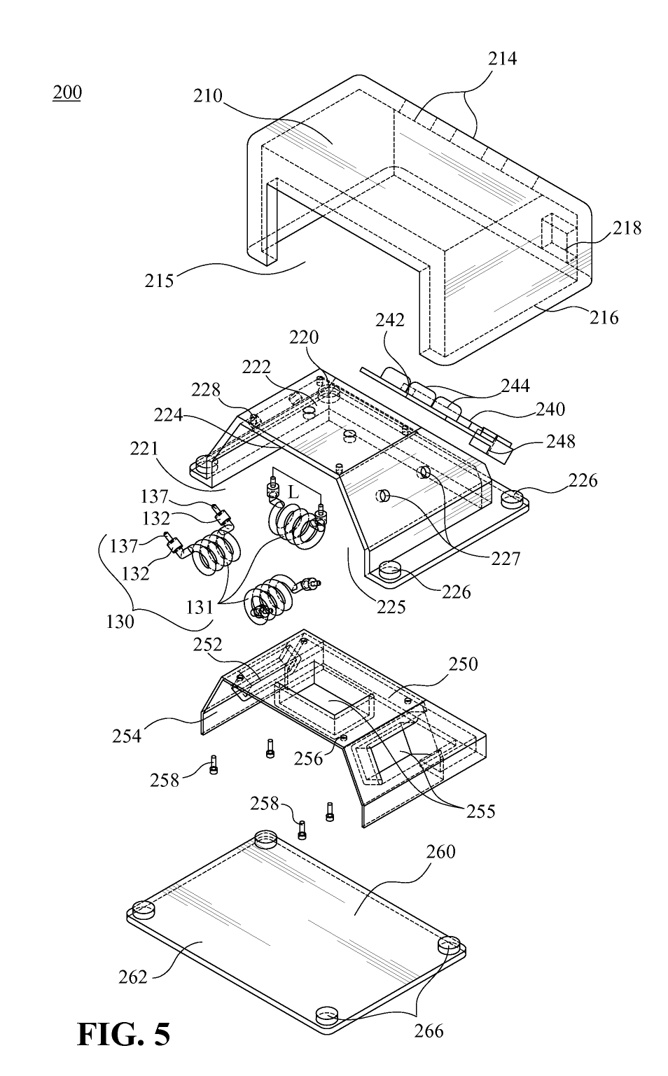

FIG. 5 shows another exemplary embodiment of the UV CCFL curing apparatus 200 of the present invention. The UV CCFL curing apparatus 200 comprises an outer casing 210 detachably attached to an inner casing 220, an UV CCFL light source 230 detachably retained onto the inner casing 220 and electrically connected to and powered by a power supply 240, a light-transmissive protective means 250 detachably attached to the inner casing 220 to receive and retain said UV CCFL light source 230 thereon. In one embodiment, the light reflective inner casing 220 having a light reflective inner wall 224 enclosing an inner chamber 221 and an outer wall 222 further includes at least one front opening 225 on a front side thereof to receive user's fingers and toes for UV curing operation in the inner or curing chamber 221. The outer casing 210 may be detachably attached to the outer wall 222 of the inner casing 220 and may be provided as both a protective means and an interactive means having different outer appearances upon user's selection from a group of customized designs. Furthermore, in one embodiment of the present invention, the UV CCFL curing apparatus 200 may further comprise a light reflective base plate 260 having an UV light reflective upper surface 262; and wherein the light reflective base plate 260 may too be detachably attached to the inner casing 220 of the apparatus 200 by means of fixations such as screws and bolts or magnets 266. In addition, the light reflective base plate 260 may facilitate UV rays emitted from said UV CCFL light source to be reflected toward the enclosed inner chamber 221 of the inner casing 220.

According to one embodiment of the present invention, the UV CCFL light source 230 of the UV CCFL curing apparatus 200 may comprise at least one UV CCFL 231 detachably retained on the light reflective inner wall 224 of inner casing 220 via electric plugs 232 integrated thereon. As shown in FIG. 5, the UV CCFLs 231 of the UV CCFL light source 230 may be configured into a spring column with a column height or length L. Said electric plugs 232 may then be disposed on two ends thereof and spaced apart from each other by said height or length L of the spring column as shown; and wherein said two ends of the UV CCFL 231 may refer to the electrodes of the lamp, operating at high voltage in a range greater or equal to one thousand volts. In one exemplary embodiment, the height or length L of the spring column may be greater than or equal to 20 mm; preferably, it may be 30 mm. In addition, the spring column form of the UV CCFL 231 of the UV CCFL light source 230 may be of an outer diameter D measured from a center C of the spring column; the diameter D may be preferably configured to be greater than or equal to 10 mm and in one exemplary embodiment, the diameter D may be 20 mm. Likewise, the electric plugs 232 of the UV CCFL 231 of the UV CCFL light source 230 integrated on the two ends of the UV CCFL 231 may further include conductive guiding spikes 237 electrically connected to connection cables (not shown) and the power supply 240 on the inner casing 220 of the apparatus 200; in other words, the conductive guiding spikes 237 may preferably extend to the outer wall 222 of the inner casing 220 and electrically connected to the power supply 240 attached thereon as a means of electrical connection as well as an installation guide facilitating user's replacement or maintenance of the UV CCFLs 231 of the UV CCFL light source 230 of the UV curing apparatus 200 of the present invention. In FIG. 5, the exemplary embodiment of the UV CCFL light source 230 of the UV CCFL curing apparatus 200 includes three individual UV CCFLs 231 disposed on three different planes of the inner wall 224 of the inner casing 220 to achieve an uniform lighting with greater illumination intensity and total wattage of light. It can however be understood that different combination and number of the UV CCFLs 231 may be provided to achieve even higher total wattage or lower wattage of light; it can be too understood that different orientations of the UV CCFLs 231 with respect to the planes of the inner wall 224 of the inner casing 220 are also possible and that different number of UV CCFLs 231 may be disposed on planes of the inner wall 224 of the inner casing 220 depending upon the corresponding number of the planes of the inner wall 224 of the inner casing 220. Furthermore, the UV CCFLs 231 of the UV CCFL light source 230 may be retained on the inner casing 220 of the apparatus 200 as the abovementioned conductive guiding spikes 237 are secured to connection cables (not show) of the power supply 240 via the apertures 227 formed on the inner casing 220; or more particular, the UV CCFLs 231 may be detachably retained between the inner wall 224 of the inner casing 220 and a light reflective cover 250 as the lamps or UV CCFLs are being installed onto the apparatus 200 by inserting the conductive guiding spikes 237 on the two end electrodes thereof and connected to the control module or power supply 240 in the apparatus 200.

Similarly, the UV CCFLs 231 of the UV CCFL light source 230 of the UV CCFL curing apparatus 200 may too comprise a light-emitting phosphor capable of emitting light of a short wavelength between 350 nm and 410 nm upon receiving an input light energy from a mercury vapor contained therein and energized by the high voltage of the electricity supplied from the control unit; and wherein said high voltage is substantially greater than one thousand volts. During curing operation of the apparatus 200, user's fingers or toes applied with an UV hardening gel placed within the inner or curing chamber 221 may then transform from a liquid state to a solid state under the exposure of the UV light shone by the UV CCFL light source 230.

According to one embodiment of the present invention as shown in FIG. 5, the UV CCFL curing apparatus 200 further comprises a light-transmissive protective means or cover 250 as a means both to protect any user's direct contact with the UV CCFL light source 230 during curing operation in the inner or curing chamber 221 and to further filter UV light of a certain wavelength such as the one in the UVC range. In one embodiment, the light-transmissive protective cover 250 comprises a first side 252 and a second side 254 opposite to the first side 252 and may be configured to detachably secured to the inner casing 220 by fixation means 258 including for example, magnets, screws, bolts and insertions via through-holes 256 formed thereon onto corresponding locking regions 228 of the inner casing 220. In another embodiment, as UV CCFLs 231 of the UV CCFL light source 230 are preferably to be installed at a height or distance away from the inner wall 224 of the inner casing 220, it may too be preferable to provide recesses 255 having dimensions accommodating to the lamp size of the UV CCFLs 231 of the UV CCFL light source 230 prescribed or used such that the recesses 255 may receive the UV CCFLs 231 of the UV CCFL light source 239 therein and preferably between the first side 252 thereof and the inner wall 224 of the inner casing 220 of the apparatus 200. Furthermore, the light-transmissive protective means or cover 250 may preferably be made of any one of the following materials including: PMMA, PC, silicon, and quartz.

During operation of the UV CCFL curing apparatus 200 of the present invention, as electricity may be drawn from an external power source (not shown) such as an AC source to the power supply 240 of the apparatus 200 and subsequently via connection cables (not show) of the power supply 240 to the UV CCFLs 231 of the UV CCFL light source 230 detachably connected thereto, the power supply 240 is capable of supplying, or handling and transmitting an electricity of a high voltage in a range of greater than or equal to one thousand volts. In one embodiment, the power supply 240 configured within the UV CCFL curing apparatus 200 of the present invention comprises a power plug 248 and a substrate 242, preferably attached to the inner casing 200 and electrically connected to the UV CCFL light source 230 via said electric plugs 232 thereof. An power adaptor capable of stepping up an input AC voltage of low voltage to high voltage may be provided external to the power supply 240 and/or the apparatus 200 of the present invention; likewise, an inverter capable of transforming AC to DC power may too be preferably provided external to the power supply 240 and/or the apparatus 200 for both safety concerns as well as maintaining the lightweight of the apparatus 200. It can however be understood that the abovementioned power adaptor and/or inverter may too be provided at an internal of the apparatus 200, preferably between the inner casing 220 and the outer casing 210 thereof.

While the present invention is disclosed in reference to the preferred embodiments or examples above, it is to be understood that these embodiments or examples are intended for illustrative purposes, which shall not be treated as limitations to the present invention. It is contemplated that modifications and combinations will readily occur to those skilled in the art, which modifications and combinations will be within the spirit of the invention and the scope of the following claims.

What is claimed is:

1. An UV CCFL curing apparatus, comprising:
a light reflective inner casing having a light reflective inner wall enclosing an inner chamber and an outer wall; wherein the inner chamber includes at least one front opening facing toward a front side of the apparatus;
an outer casing detachably attached to the outer wall of the inner casing;
an UV CCFL light source comprising at least one UV CCFL detachably retained on the light reflective inner wall of inner casing via electric plugs integrated thereon;
a light-transmissive protective means comprising a first side and a second side opposite to the first side, configured to detachably secured to the inner casing and to receive the UV CCFL light source between the first side thereof and the inner wall of the inner casing;
a power supply capable of supplying an electricity of a high voltage, comprising a power input plug and a substrate attached to the inner casing and electrically connected to the UV CCFL light source via said electric plugs thereof.

2. The UV CCFL curing apparatus as claimed in claim 1, wherein the UV CCFL of the UV CCFL light source further comprises light-emitting phosphor capable of emitting light of a short wavelength between 350 nm and 410 nm upon receiving an input light energy transmitted from a mercury vapor contained therein and energized by the high voltage of the electricity supplied from the power supply

3. The UV CCFL curing apparatus as claimed in claim 1, wherein the at least one UV CCFL of the UV CCFL light source is configured into a spiral shape.

4. The UV CCFL curing apparatus as claimed in claim 1, wherein the electric plugs integrated on said at least one UV CCFL of the UV CCFL light source are arranged on two ends thereof separated by a width of the at least one UV CCFL such that the electricity of said high voltage supplied from the power supply is transmitted to said two ends of the at least one UV CCFL spaced apart from each other.

5. The UV CCFL curing apparatus as claimed in claim 1, wherein the electric plugs integrated on said at least one UV CCFL of the UV CCFL light source further comprises conductive guiding spikes extending to the outer wall of the inner casing and electrically connected to the power supply.

6. The UV CCFL curing apparatus as claimed in claim 1, wherein the light-transmissive protective means detachably secured to the inner casing is at a distance away from the inner wall of the inner casing such that the at least one UV CCFL of the UV CCFL light source is received between the first side of the protective means and the inner wall of the inner casing.

7. The UV CCFL curing apparatus as claimed in claim 1, wherein the inner wall of the inner casing comprises a plurality of planes angled from one another at an angle between 90 degree and 175 degree; wherein said plurality of planes comprises a horizontal top plane.

8. The UV CCFL curing apparatus as claimed in claim 7, wherein the UV CCFL light source is detachably retained on said horizontal top plane of the inner wall of the inner casing.

9. The UV CCFL curing apparatus as claimed in claim 1, wherein the power supply further comprises at least one button electrically connected to the substrate and extending to an external of the outer casing.

10. The UV CCFL curing apparatus as claimed in claim 1, wherein the power supply further comprises an external power adapter and wherein the high voltage supplied by the power supply via said power adapter to the at least one UV CCFL of the UV CCFL light source is substantially greater than one thousand volts.

11. The UV CCFL curing apparatus as claimed in claim 1, wherein the light-transmissive protective means is a cover made of any one of the following materials including: PMMA, PC, silicon, quartz.

12. The UV CCFL curing apparatus as claimed in claim 1, wherein the electric plugs of the UV CCFL light source comprises dielectric material made of any one of the following materials of: silicon, rubber and ceramics.

13. The UV CCFL curing apparatus as claimed in claim 1, further comprises a light reflective base plate detachably attached to the inner casing such that UV rays emitted from said UV CCFL light source are reflected by the base plate toward the enclosed inner chamber of the inner casing.

14. The UV CCFL curing apparatus as claimed in claim 13, wherein the light reflective base plate is detachably attached to the inner casing by any one of the following fixation means including screws, bolts and magnets.

15. The UV CCFL curing apparatus as claimed in claim 1, wherein the light-transmissive protective means base having the first side facing toward the UV CCFL light source and the second side facing toward the inner chamber of the inner casing is detachably attached to the inner casing by any one of the following fixation means including screws, bolts and magnets.

16. An UV CCFL curing apparatus, comprising:
a light reflective inner casing having a light reflective inner wall enclosing an inner chamber and an outer wall; wherein the inner chamber includes a front opening facing toward a front side of the apparatus;
an outer casing detachably attached to the outer wall of the inner casing;
an UV CCFL light source comprising at least one UV CCFL detachably retained on the light reflective inner wall of inner casing via electric plugs integrated thereon; wherein the at least one UV CCFL is configured into a spring column having said electric plugs disposed on two ends thereof and spaced apart from each other by a height of the spring column;
a light-transmissive protective means comprising a first side and a second side opposite to the first side, configured to detachably secured to the inner casing and to receive the UV CCFL light source between the first side thereof and the inner wall of the inner casing; and
a power supply capable of supplying an electricity of a high voltage, comprising a power plug and a substrate attached to the inner casing and electrically connected to the UV CCFL light source via said electric plugs thereof.

17. The UV CCFL curing apparatus as claimed in claim 16, wherein the UV CCFL of the UV CCFL light source further comprises light-emitting phosphor capable of emitting light of a short wavelength between 350 nm and 410 nm upon receiving an input light energy from a mercury vapor contained therein and energized by the high voltage of the electricity supplied from the control unit; and wherein said high voltage is substantially greater than one thousand volts.

18. The UV CCFL curing apparatus as claimed in claim 16, wherein the electric plugs integrated on said at least one UV CCFL of the UV CCFL light source further comprises conductive guiding spikes extending to the outer wall of the inner casing and electrically connected to the power supply.

19. The UV CCFL curing apparatus as claimed in claim 16, further comprises a light reflective base plate detachably attached to the inner casing such that UV rays emitted from said UV CCFL light source are reflected by the base plate toward the enclosed inner chamber of the inner casing.

20. The UV CCFL curing apparatus as claimed in claim 16, wherein the light-transmissive protective means further comprises at least one recesses having a dimension accommodating to the at least one UV CCFL of the UV CCFL light source to receive said at least one UV CCFL therein; and wherein the light-transmissive protective means is a cover made of any one of the following materials including: PMMA, PC, silicon, and quartz.
